(19) United States
(12) Patent Application Publication
(10) Pub. No.: US 2017/0192151 A1
(43) Pub. Date: Jul. 6, 2017

(54) LIGHT GUIDING PLATE AND BACKLIGHT MODULE USING THE SAME

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Lingyan CHEN, Shenzhen, Guangdong (CN); Gege ZHOU, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD., Wuhan, Hubei (CN)

(21) Appl. No.: 14/905,817

(22) PCT Filed: Jul. 7, 2015
(86) PCT No.: PCT/CN2015/083434

§ 371 Date: Jan. 17, 2016

(30) Foreign Application Priority Data
Jun. 18, 2015 (CN) 201510340306.6

(51) Int. Cl. F21V 8/00

(52) U.S. Cl. CPC G02B 6/0035; G02B 6/0068

(57) ABSTRACT

A light guiding plate and a backlight module are proposed. The light guiding plate includes light guiding matrixes. Two adjacent light guiding matrixes are equally spaced and the light guiding matrixes has two adjacent light guiding units. The light guiding plate has a side closed to a light source, and sizes of the light guiding unit increases with a distance from the side. Therefore, the reflected light from the light guiding plate is improved and thus make the emitted light even. This result reduces the interference phenomenon because it can prevent the reflected light from focusing on a certain area. Or, the light guiding matrix is shaped as a fold line or a curve. This structure makes the light emitted from the entire light guiding plate even and reduces the interference phenomenon because it can prevent the reflected light from focusing on a certain area.

### CROSS REFERENCE

This application claims the priority of Chinese Patent Application No. 201510340306.6, entitled “Flat panel and flat panel display”, filed on Jun. 18, 2015, the disclosure of which is incorporated herein by reference in its entirety.

### FIELD OF THE INVENTION

The present disclosure relates to a liquid crystal display, and more particularly to a light guiding plate and a backlight module using the same.

### BACKGROUND OF THE INVENTION

Liquid crystal displays (LCDs) cannot generate a light by itself. Therefore, the LCD needs to use a backlight module as its light source. A light guiding plate is an important component of the backlight module for guiding the light generated by the light source to emit in a correct direction. For example, the light guiding plate receives the light from a point light source or a line point source and emits the light in a form of a surface light source. In general, the light is emitted into a side of the light guiding plate and emitted from the front side, which is vertical to the side, because the light is totally reflected by transparent plate interfaces of the light guiding plate.

Please refer to FIG. 1. In FIG. 1, light guiding units are positioned in a form of sloping lines on the light guiding plate. Because these light guiding units are arranged in a regular way, the light guiding effect is only good in a certain direction. Therefore, when the light passes through the light guiding plate, an image containing sloping stripes is often generated. In addition, an LCD panel often has a stripe-shaped light shielding layer (the black matrix for separating red, green, blue color filters), which may introduce a interference phenomenon because the light emitted from the light guiding plate is interfered by the stripe-shape light shielding layer. Therefore, the display quality of the LCD decreases because the interference fringes may be displayed.

### SUMMARY OF THE INVENTION

One objective of the present disclosure is to provide a light guiding plate emitting an even light.

In order to achieve the aforementioned objective, this is provided a light guiding plate including a plurality of light guiding matrixes. Two adjacent light guiding matrixes of the plurality of light guiding matrixes have a space between the two adjacent light guiding matrixes, and at least one of the light guiding matrixes has two adjacent light guiding units. The light guiding plate has a side closed to a light source, and sizes of the light guiding unit increases with a distance from the side.

In the light guiding plate, each of the light guiding matrixes has a shape of a line and is parallel to the side.

In the light guiding plate, each of the light guiding matrixes has a shape of a line and the side and the each of the light guiding matrixes has an angle.

In the light guiding plate, each of the light guiding matrixes has a shape of a fold line.

In the light guiding plate, each of the light guiding matrixes has a shape of a curve.

In the light guiding plate, each of the two adjacent light guiding matrixes are equally spaced.

In the light guiding plate, quantities of light guiding matrixes increase with the distance from the side.

In addition, this is provided a light guiding plate including a plurality of light guiding matrixes. Two adjacent light guiding matrixes of the plurality of light guiding matrixes have a space between the two adjacent light guiding matrixes, and at least one of the light guiding matrixes has two adjacent light guiding units, and wherein each of the light guiding matrixes has a shape of a curve.

In the light guiding plate, the light guiding plate has a side closed to a light source, and sizes of the light guiding unit increases with a distance from the side.

In addition, this is provided a backlight module including the aforementioned light guiding plate and a light source positioned correspondingly to the side of the light guiding plate.

The backlight module comprises two light sources respectively positioned corresponding to two sides of the light guiding plate.

The light guiding plate and the backlight module according to an exemplary embodiment can emit light having improved uniformity. Sizes of the light guiding units in the light guiding plate increase with the distance from the light sources. Therefore, the reflected light emitted from the middle of the light guiding plate is improved and thus make the light emitted from the entire light guiding plate even. This result reduces the interference phenomenon because it can prevent the reflected light emitted from the entire light guiding plate from focusing on a certain area. Or, the light guiding matrix in the light guiding plate has a shape of a fold line or a curve. This structure make the light emitted from the entire light guiding plate even. This structure reduces the interference phenomenon because it can prevent the reflected light emitted from the entire light guiding plate from focusing on a certain area.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a diagram showing a structure of a conventional light guiding plate.

FIG. 2 is a diagram showing a structure of a light guiding plate according to a first embodiment.

FIG. 3 is a diagram showing a structure of a backlight module according to a first embodiment.

FIG. 4 is a diagram showing a structure of a light guiding plate according to a second embodiment.

FIG. 5 is a diagram showing a structure of a backlight module according to a second embodiment.

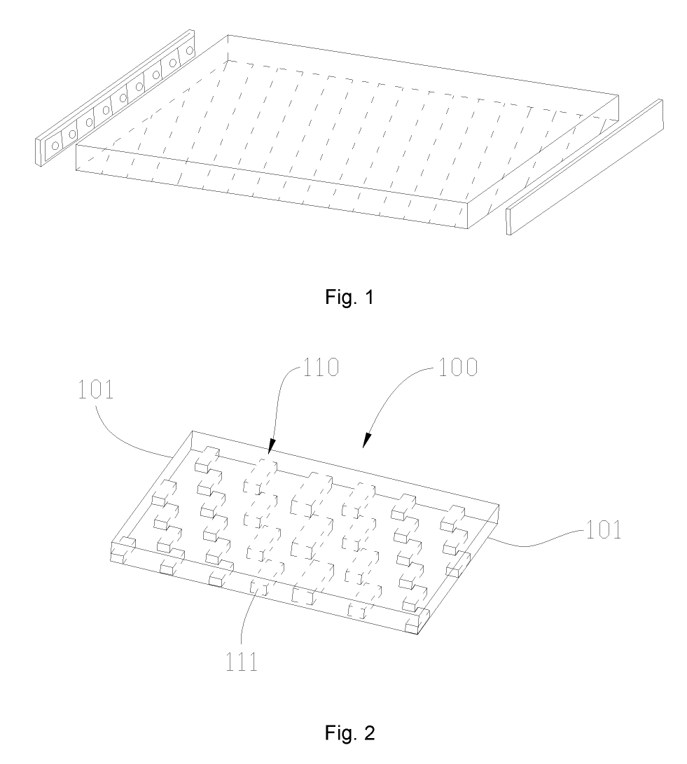

### DETAILED DESCRIPTION OF PREFERRED EMBODIMENTS

Embodiments of the present invention are described in detail with the technical matters, structural features, achieved objects, and effects with reference to the accompanying drawings as follows.

Specifically, the terminologies in the embodiments of the present invention are merely for describing the purpose of the certain embodiment, but not to limit the invention. Examples and the appended claims be implemented in the present invention requires the use of the singular form of the book “an”, “the” and “the” are intended to include most forms unless the context clearly dictates otherwise. It should also be understood that the terminology used herein that “and/or” means and includes any or all possible combinations of one or more of the associated listed items.

Please refer to FIG. 2, which is a diagram showing a structure of a light guiding plate according to a first embodiment of the present invention. In FIG. 2, the light guiding plate comprises at least one light guiding matrix 110. For example, a light guiding matrix 110 can be a column of light guiding units 111. Two columns 110 are arranged to have a space between each other, and each column 110 comprises at least two light guiding units 111. The light guide plate 110 has sides 101 close to the light sources. The sizes of the light guiding units 111 increase with the distance from the sides 101.

In this embodiment, the sizes of the light guiding units 111 increase with the distance from the sides 101. Therefore, the reflected light emitted from the middle of the light guiding plate 100 is improved and thus make the light emitted from the entire light guiding plate 100 even. This result reduces the interference phenomenon because it can prevent the reflected light emitted from the entire light guiding plate 100 from focusing on a certain area.

Optimally, the light guiding matrix 110 has a shape of a line, and the angle between the line and the side 101 is an acute angle. In an exemplary embodiment, the shape of the light guiding matrix 110 may be a shape of the links of all light guiding units 111.

In another embodiment, the light guiding matrix 110 has a shape of a line and light guiding matrix 110 and the side 101 are parallel.

In another embodiment, the light guiding matrix 110 has a shape of a curve or a fold line.

Optimally, two of the light guiding matrixes 110 has a space between them and the space between each of the two light guiding matrixes 110 is identical.

In another embodiment, the quantity of the light guiding matrixes 110 increases with the distance from the side 101. This means that the space between the light guiding matrixes 110 decreases with the distance from the side 101.

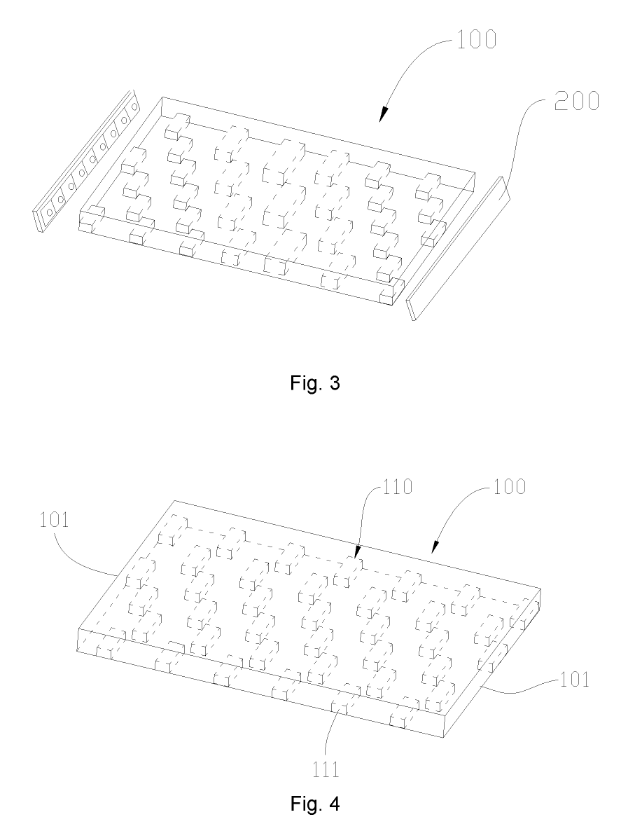

Please refer to FIG. 3. As shown in FIG. 3, a backlight module is provided. The backlight module comprises the aforementioned 100 and light sources 200. The light sources 200 are arranged correspondingly to the sides 101. Specifically, the backlight module comprises two light sources 200, respectively positioned according to the two sides 101.

Please refer to FIG. 4. As shown in FIG. 4, a light guiding plate 100 is provided. The light guiding plate 100 comprises at least a light guiding matrix 110. Each of two adjacent light guiding matrixes 110 has a space between them. In addition, each of the light guiding matrixes 110 comprises at least adjacent two light guiding units 111 and has a shape of a fold line or a curve.

As previously mentioned, the light guiding matrix has a shape of a fold line or a curve. This structure make the light emitted from the entire light guiding plate 100 even. This structure reduces the interference phenomenon because it can prevent the reflected light emitted from the entire light guiding plate 100 from focusing on a certain area.

The light guiding 100 has sides 101, which are closed to the light sources. As shown in FIG. 4, the sizes of the light guiding units 110 increase with the distance from the sides 101.

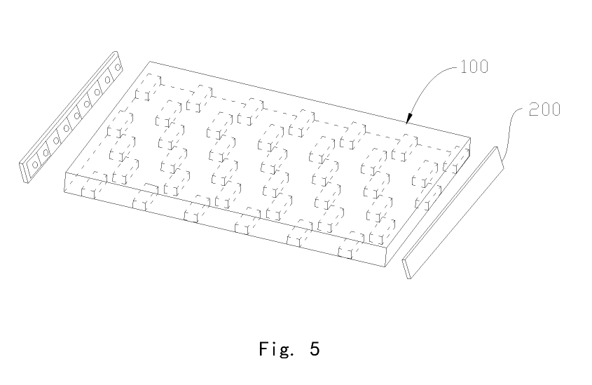

Please refer to FIG. 5. A backlight module is provided. The backlight module comprises the aforementioned light guiding plate 100 and light sources 200. The light sources 200 are arranged correspondingly to the sides 101. Specifically, the backlight module comprises two light sources 200, respectively positioned according to the two sides 101.

Above are embodiments of the present invention, which does not limit the scope of the present invention. Any modifications, equivalent replacements or improvements within the spirit and principles of the embodiment described above should be covered by the protected scope of the invention.

1. A light guiding plate, comprising:
a plurality of light guiding matrixes, wherein two adjacent light guiding matrixes of the plurality of light guiding matrixes have a space between the two adjacent light guiding matrixes, and at least one of the light guiding matrixes has two adjacent light guiding units, and
wherein the light guiding plate has a side closed to a light source, and sizes of the light guiding unit increases with a distance from the side.

2. The light guiding plate of claim 1, wherein each of the two adjacent light guiding matrixes are equally spaced.

3. The light guiding plate of claim 1, wherein quantities of light guiding matrixes increase with the distance from the side.

4. The light guiding plate of claim 1, wherein each of the light guiding matrixes has a shape of a line and is parallel to the side.

5. The light guiding plate of claim 3, wherein each of the two adjacent light guiding matrixes are equally spaced.

6. The light guiding plate of claim 3, wherein quantities of light guiding matrixes increase with the distance from the side.

7. The light guiding plate of claim 1, wherein each of the light guiding matrixes has a shape of a line and the side and the each of the light guiding matrixes has an angle.

8. The light guiding plate of claim 7, wherein each of the two adjacent light guiding matrixes are equally spaced.

9. The light guiding plate of claim 7, wherein quantities of light guiding matrixes increase with the distance from the side.

10. The light guiding plate of claim 1, wherein each of the light guiding matrixes has a shape of a fold line.

11. The light guiding plate of claim 10, wherein each of the two adjacent light guiding matrixes are equally spaced.

12. The light guiding plate of claim 10, wherein quantities of light guiding matrixes increase with the distance from the side.

13. The light guiding plate of claim 1, wherein each of the light guiding matrixes has a shape of a curve.

14. The light guiding plate of claim 13, wherein each of the two adjacent light guiding matrixes are equally spaced.

15. The light guiding plate of claim 13, wherein quantities of light guiding matrixes increase with the distance from the side.

16. A light guiding plate, comprising a plurality of light guiding matrixes, wherein two adjacent light guiding matrixes of the plurality of light guiding matrixes have a space between the two adjacent light guiding matrixes, and at least one of the light guiding matrixes has two adjacent light guiding units, and wherein each of the light guiding matrixes has a shape of a curve.

17. The light guiding plate of claim 16, wherein the light guiding plate has a side closed to a light source, and sizes of the light guiding unit increases with a distance from the side.

18. (canceled)

19. The backlight module of claim 18, wherein the backlight module comprises two light sources respectively positioned corresponding to two sides of the light guiding plate.

20. A backlight module, comprising a light guiding plate claimed in claim 1 and a light source positioned correspondingly to the side of the light guiding plate.
